(19) United States
(12) Patent Application Publication
(10) Pub. No.: US 2014/0159918 A1
(43) Pub. Date: Jun. 12, 2014

(54) METHOD AND DEVICE FOR DETECTING THE PRESENCE OF AN AUTOMATIC DEFIBRILLATOR

(71) Applicants: Laurent Pichard, Frichemesnil (FR); Stephane Di Marco, Cergy (FR); Jacques Lewiner, Saint-Cloud (FR)

(72) Inventors: Laurent Pichard, Frichemesnil (FR); Stephane Di Marco, Cergy (FR); Jacques Lewiner, Saint-Cloud (FR)

(73) Assignee: FINSECUR, Nanterre (FR)

(21) Appl. No.: 14/232,617

(22) PCT Filed: Jul. 24, 2012
(86) PCT No.: PCT/FR2012/000307

§ 371 Date: Feb. 4, 2014

(30) Foreign Application Priority Data
Jul. 12, 2011 (FR) FR1102203

(51) Int. Cl. G08C 17/02

(52) U.S. Cl. CPC G08C 17/02
USPC 340/870.07

(57) ABSTRACT

A device for detecting the presence of an automatic defibrillator. The device comprises a detector, a communications device and an activation device. The detector detects the presence of an automatic defibrillator in its operation position and to defibrillator relating to the automatic defibrillator. The communications device is configured to transmit he e data of the automatic defibrillator to a management device. The activation device is configured to activate at least one of the communication device and the detector in response to a pre-determined event.

The present invention relates to a method for detecting the presence of an automatic defibrillator and a device making it possible to detect the presence of an automatic defibrillator. At least one embodiment of the present invention relates to a method for identifying an automatic defibrillator and a device making it possible to identify an automatic defibrillator.

Automatic defibrillators are apparatuses that analyze heart activity automatically or semi-automatically, which prevents any operating errors by the operator of such an apparatus. In the case of a person suffering from cardio-respiratory arrest, a witness who has access to an automatic defibrillator has the opportunity to intervene rapidly, which in many cases permits cardio-respiratory activity to be restored. For this purpose, automatic defibrillators are positioned in public and private premises at suitable positions. The automatic defibrillators are placed on mounts and, to prevent them being removed for reasons other than those originally intended, they are sometimes attached to the mount by means of a wire, sometimes sealed, which can be broken in cases of real need.

However, and for various reasons, defibrillators can be removed from their mounts, which is a serious handicap in terms of safety. Finally, it is desirable, in certain cases, to be able to check the condition of automatic defibrillators in real time and, for example, the condition of their power supply system, cell or battery.

This assumes the installation of an electrical network linked to each automatic defibrillator mount, which is feasible in new premises but very difficult to implement in old premises, taking into account the fact that electrical cables have to be passed to locations where this is sometimes difficult and the very high cost such installations entail.

The aim of the invention in at least one embodiment is to overcome drawbacks of the state of the art and to make improvements.

For this purpose, a first aspect of the invention proposes a device for detecting the presence of an automatic defibrillator, the device comprising: means of detecting the presence of an automatic defibrillator, designed to detect the presence of an automatic defibrillator in its operating position and to obtain defibrillator data relating to the automatic defibrillator; communication means able to transmit the automatic defibrillator data to a management device; and activation means able to activate at least one of the communication means and detection means in response to a predefined event.

The defibrillator data can comprise data allowing the automatic defibrillator to be identified, or data indicating the presence or absence of the automatic defibrillator.

According to an embodiment, the activation means are able to activate the communication means when the means of detecting the presence of an automatic defibrillator detect that the automatic defibrillator is not in its operating position.

According to an embodiment, the presence detection means comprise automatic defibrillator identifying means designed to obtain data identifying the automatic defibrillator.

According to an embodiment, the device comprises a mount to support an automatic defibrillator, with the mount comprising an identifying element for the mount to supply the management device with identifying data for the mount, allowing the mount to be identified.

According to an embodiment, the identifying means are arranged so as to communicate with the automatic defibrillator's identifying element via a wireless connection in order to verify an identifying code for the automatic defibrillator. According to an embodiment, the identifying means comprise a device for identification by RF.

According to an embodiment, the identifying means comprise an optical reader and image processing means for processing an image coming from the optical reader.

According to an embodiment, the optical reader comprises a linear network of diodes, a two-dimensional optical sensor, a camera, or a laser. According to an embodiment, the communication means are able to transmit identifying data by means of a wired connection.

According to an embodiment, the communication means are able to transmit identifying data by means of a wireless connection. According to another embodiment, the communication means are able to transmit identifying data by means of a wired powerline connection.

According to an embodiment, the activation means are able to activate the identifying means at predefined times.

According to an embodiment, the activation means are able to activate the identifying means in response to an interrogation signal from the management device.

According to an embodiment, the device also comprises means of detecting the presence of an automatic defibrillator in its operating position.

According to an embodiment, the activation means are able to activate the identifying means at predefined times after the means of detecting the presence of an automatic defibrillator have detected the removal of an automatic defibrillator from its mount and said means of detecting the presence of an automatic defibrillator have detected an automatic defibrillator being placed back on its mount.

According to an embodiment, the device also comprises signaling means for signaling said absence of the automatic defibrillator at the location of the automatic defibrillator identifying device.

According to an embodiment, the device also comprises means of detecting the presence of at least one person in the vicinity of the automatic defibrillator identifying device, wherein the signaling means are able to signal a visible or audible alarm when the presence of a person is detected.

According to an embodiment, the device also comprises means of detecting the presence of at least one person in the vicinity of the automatic defibrillator presence detection device, wherein the signaling means are able to signal a visible or audible alarm when the automatic defibrillator presence detection means detect that the automatic defibrillator is not in its operating position and when the presence of a person is detected in the vicinity of the automatic defibrillator presence detection device.

According to an embodiment, the presence detection means comprise a detector of infrared rays coming from an associated emitter of infrared rays or coming from a person in the vicinity of the device for detecting the presence or absence of an automatic defibrillator.

According to an embodiment, the device also comprises means for checking the working condition of the automatic defibrillator identifying device so as to supply information representative of the working condition to the management device.

According to an embodiment, the automatic defibrillator is powered by a battery, the charger for this battery being placed in the mount connected to the electrical network.

According to an embodiment, the automatic defibrillator has its own electrical power supply source (cell or battery).

According to an embodiment, the working condition verification means are arranged so as to verify the power status of the identifying device of the automatic defibrillator.

According to an embodiment, the working condition verification means are arranged so as to measure a parameter representative of the quantity of power remaining in the power source.

According to an embodiment, the working condition verification means are arranged so as to measure a parameter representative of the quantity of power remaining in a power supply source for the automatic defibrillator presence detection device.

According to an embodiment, the working condition verification means are arranged so as to measure a parameter representative of the quantity of power remaining in a power supply source for the automatic defibrillator.

According to an embodiment, the working condition verification means are arranged so as to verify the condition of the wireless connection with the management device.

According to an embodiment, the working condition verification means are arranged so as to measure a parameter representative of the reception quality of a predefined radio verification signal coming from said management device.

According to an embodiment, the working condition verification means are arranged to measure the signal-to-noise ratio or the intensity of the predefined radio verification signal.

According to an embodiment, the working condition verification means are arranged so as to measure a parameter representative of the quantity of power remaining in a power supply source for the automatic defibrillator.

According to an embodiment, the signaling means are arranged so as to signal an operating fault.

According to an embodiment, the device also comprises response means able to detect the reception of an interrogation signal coming from the management device and, in response to the reception of the interrogation signal, to transmit information representative of the identifying device's working condition, information representative of the automatic defibrillator's working condition and/or the identifying data to the management device.

According to an embodiment, the device also comprises response means able to detect the reception of an interrogation signal coming from the management device and, in response to the reception of the interrogation signal, to transmit information representative of the automatic defibrillator presence detection device's working condition and/or identifying data to the management device.

According to an embodiment, the device also comprises response means able to detect the reception of an interrogation signal coming from the management device and, in response to the reception of the interrogation signal, to transmit information representative of the working condition of the automatic defibrillator to the management device.

In an embodiment, the activation means are able to activate the communication means when the means of detecting the presence of an automatic defibrillator detect the absence of the automatic defibrillator from its operating position.

According to an embodiment, the activation means are able to activate the identifying means at predefined times after the means of detecting the presence of an automatic defibrillator have detected the automatic defibrillator's absence from its operating position and said means have detected the automatic defibrillator being placed back in its operating position.

A second aspect of the invention proposes a management device for a security system, comprising: communication means able to be linked via a wireless connection to at least one automatic defibrillator identifying device according to the first aspect of the invention so as to receive automatic defibrillator identifying data; and data processing means making it possible to obtain information about an automatic defibrillator as a function of the automatic defibrillator identifying data received.

According to an embodiment, the communication means are wired and use the mount's power supply wires by means of powerline technology.

According to another embodiment the communication means use a wireless connection. According to an embodiment, the processing means are arranged so as to obtain information about the automatic defibrillator's working condition and/or the location of the automatic defibrillator. According to an embodiment, the management device also comprises a memory for storing information about at least one automatic defibrillator.

According to an embodiment, the data processing means are arranged so as to obtain the data identifying the automatic defibrillator's mount; the data identifying the automatic defibrillator; and so as to verify that the data identifying the automatic defibrillator's mount correspond to the data provided for identifying the automatic defibrillator.

A third aspect of the invention proposes an automatic defibrillator device comprising: electrodes to be placed on the victim's chest, designed to analyze the heart rate and to deliver an electric shock; a power supply source; a defibrillator housing receiving the power supply source and to which the electrodes are connected; a memory, e g. a flash memory type of memory card or an internal memory, for recording heart function parameters (electrocardiograms, heart rate analysis, defibrillation sequences, number of shocks, etc.); and an identifying element, which can be read by an automatic defibrillator identifying device according to the first aspect of the invention, for identifying the automatic defibrillator.

In an embodiment, the automatic defibrillator device can also comprise a loudspeaker for guiding the user with the help of audible instructions.

According to an embodiment, the identifying element is arranged so as to communicate with the automatic defibrillator identifying means via a wireless connection in order to supply an identifying code for the automatic defibrillator.

According to an embodiment, the identifying element is arranged so as to supply an identifying code by RF.

According to an embodiment, the identifying element comprises the identifying data in optical form. According to an embodiment, the identifying element comprises the identifying data in electronic form. A fourth aspect of the invention proposes a monitoring method for a security system comprising a management device and at least one automatic defibrillator identifying device able to communicate with the management device by means of a wireless connection; the method comprising: a step of activating the identifying device's identifying means; a step of identifying an automatic defibrillator by the identifying means; a step of transmitting identifying data to the management device; and a step of verifying the identifying data.

Another aspect of the invention proposes a monitoring method for a security system comprising a management device and at least the automatic defibrillator presence detection device able to communicate with the management device; the method comprising: a step of activating the defibrillator presence detection means; a step of detecting the presence of an automatic defibrillator by the defibrillator presence detection means; a step of transmitting defibrillator data to the management device; and a step of verifying the defibrillator data.

According to an embodiment, the activation step comprises a step of activating the identifying device's identifying means; the presence detection step comprises a step of identifying an automatic defibrillator by the identifying means; and the defibrillator data verification step comprises a step of verifying the identifying data. According to an embodiment, the method also comprises a step of obtaining data identifying the automatic defibrillator mount and a verification step for verifying that the automatic defibrillator identifying data correspond to the mount identifying data.

According to an embodiment, the method comprises the transmission of information representative of the automatic defibrillator identifying device's working condition to the management device.

For this purpose, another aspect of the invention proposes an automatic defibrillator identifying device, the device comprising: automatic defibrillator identifying means making it possible to read an identifying element on an automatic defibrillator so as to obtain identifying data for the automatic defibrillator; activation means able to activate the identifying means in response to a predefined event; and communication means able to transmit the automatic defibrillator identifying data to a management device.

Embodiments of the present invention make it possible to avoid one or more of the problems mentioned and also to provide a real-time check of the arrangement of automatic defibrillators in the premises to be monitored.

The invention will be described in greater detail with reference to the following figures included in an appendix.

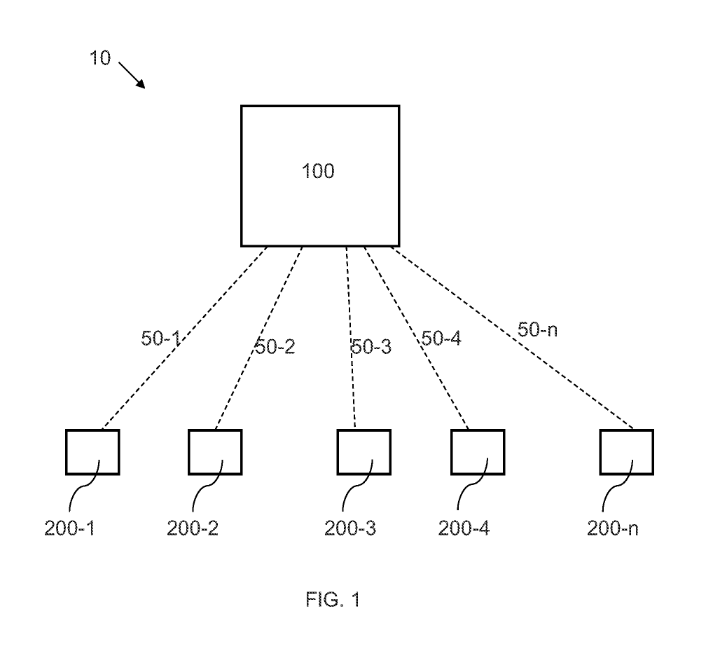

FIG. 1 is a schematic representation of elements of a security system according to at least one embodiment of the invention.

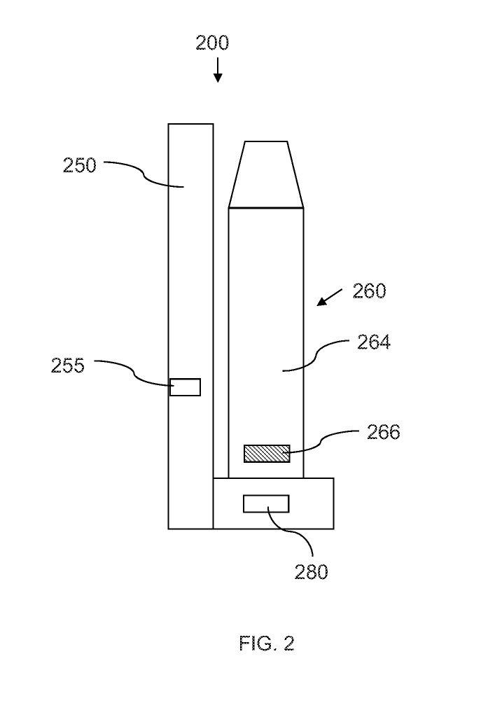

FIG. 2 is a schematic representation of an automatic defibrillator apparatus according to at least one embodiment of the invention.

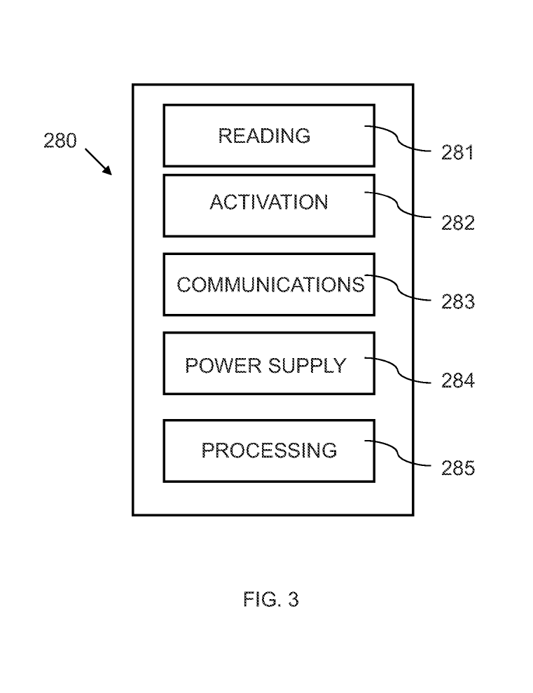

FIG. 3 is a schematic representation of a device for detecting the presence of an automatic defibrillator according to a first embodiment of the invention.

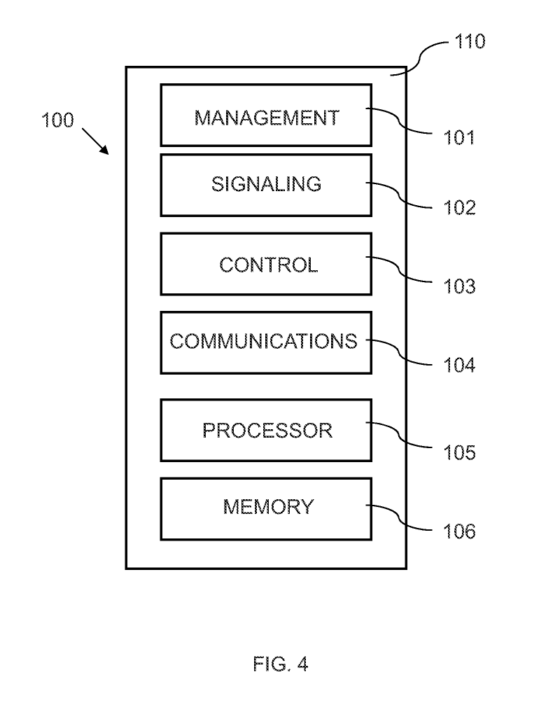

FIG. 4 is a schematic representation of a central monitoring station according to an embodiment of the invention.

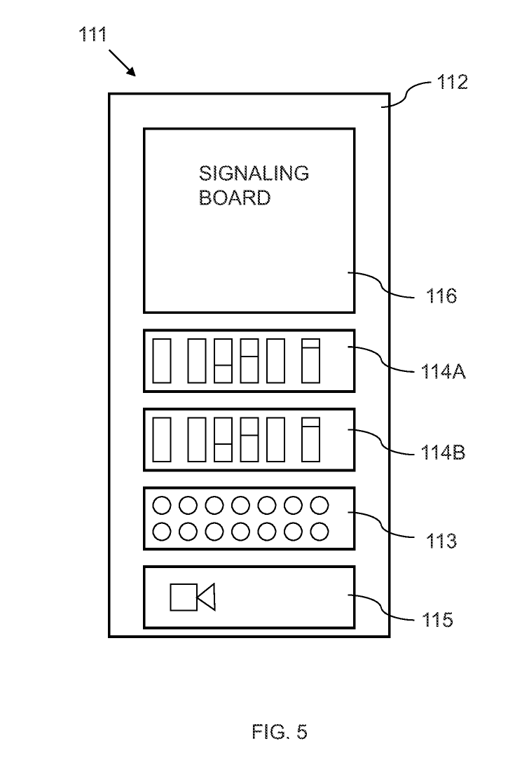

FIG. 5 is a schematic representation of the front face of a central monitoring station housing according to an embodiment of the invention.

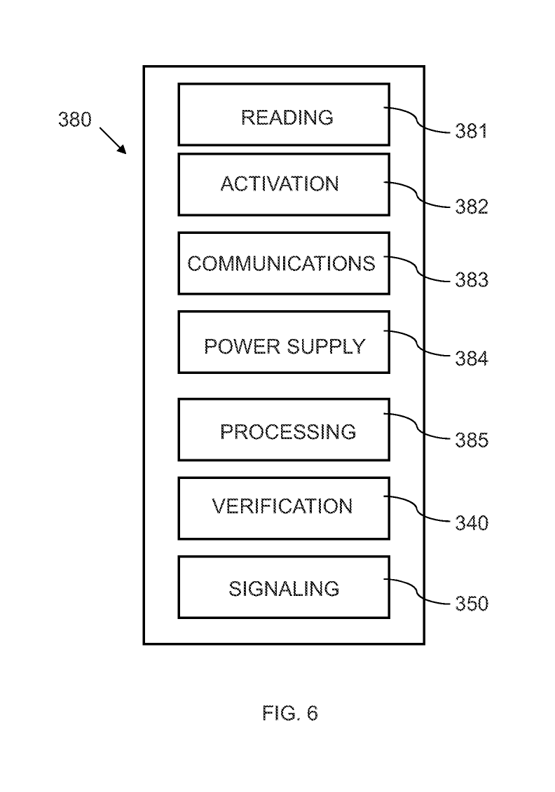

FIG. 6 is a schematic representation of an automatic defibrillator identifying device according to a second embodiment of the invention.

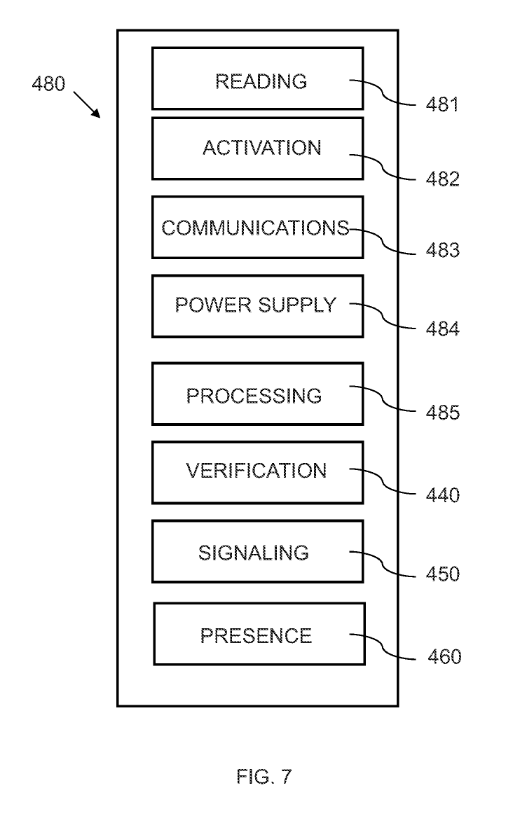

FIG. 7 is a schematic representation of an automatic defibrillator identifying device according to a third embodiment of the invention.

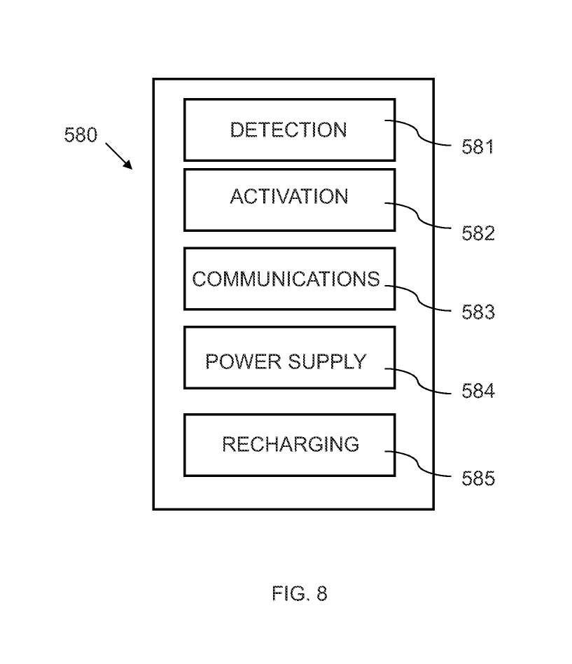

FIG. 8 is a schematic representation of a device for detecting the presence of an automatic defibrillator according to a fourth embodiment of the invention.

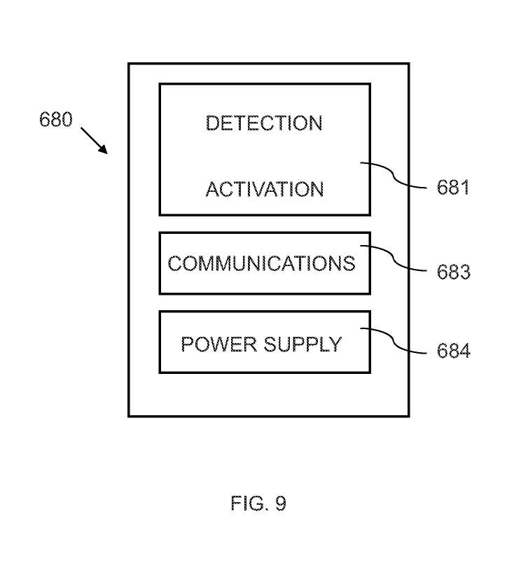

FIG. 9 is a schematic representation of a device for detecting the presence of an automatic defibrillator according to a fifth embodiment of the invention.

An automatic defibrillator monitoring system 10 according to a first embodiment of the invention is represented schematically in FIG. 1. This system comprises a central monitoring station 100 connected by means of the wireless connections 50-1 . . . 50-n to automatic defibrillator apparatuses 200-1 . . . 200-n, distributed in an area to be protected.

An automatic defibrillator apparatus 200 according to a first embodiment of the invention is represented schematically in FIG. 2. The automatic defibrillator device comprises an automatic defibrillator mount 250, an automatic defibrillator 260 and an automatic defibrillator presence detection device 280. The automatic defibrillator mount 250 is designed in a manner known per se to support an automatic defibrillator 260 at a defibrillator station. The mount 250 has an identifying element 255 allowing the automatic defibrillator mount 250 to be identified.

The automatic defibrillator 260 is an automatic defibrillator intended to analyze heart activity automatically. In the case of a person suffering from cardio-respiratory arrest, a witness who has access to an automatic defibrillator has the opportunity to intervene rapidly, which in many cases permits cardio-respiratory activity to be restored.

The automatic defibrillator 260 is equipped with an identifying element 266 that comprises an identifying code allowing the automatic defibrillator 260 to be identified.

The automatic defibrillator presence detection device 280 according to a first embodiment of the invention is represented schematically in FIG. 3. It comprises a reading device 281 for reading the identifying code of the identifying element 266 allowing an automatic defibrillator to be identified; an activation circuit 282 for activating the reading device 281, a communications module 283 comprising a wireless interface for linking the presence detection device 280 to the central monitoring station 100 of the security system by means of the wireless connection 50; a power supply battery 284 for powering the automatic defibrillator presence detection device 280.

The automatic defibrillator 260 is placed on its automatic defibrillator mount with the automatic defibrillator identifying element 266 positioned facing the reading means 281 of the defibrillator presence detection device 280. At given times, the activation device 282 activates the reading device 281, which then captures the automatic defibrillator identifying code on the identifying element 266 of the automatic defibrillator 260. By reading the identifying code on the defibrillator, the presence of the defibrillator in its operating position is detected.

The given times can, for example, correspond to the times of requests, made by the central monitoring station 100, transmitted to the automatic defibrillator apparatuses 200 using radio waves. The corresponding messages are received by the communications module 283 of the presence detection device 280. In response, the activation circuit 282 activates the reading means of the reading device 281, which receives the identifying code of the identifying element 266 of the automatic defibrillator 260 and transmits it to the communications module 283, which retransmits it by radio to the central monitoring station 100. In a particular embodiment the identifying code 255 of the mount 250 of the automatic defibrillator 260 can be transmitted to the control unit with the automatic defibrillator identifying code 266. In another embodiment the mount 250 can be identified by the control unit 100 by means of the address of the source of the message containing the identifying code of the automatic defibrillator 260.

In another embodiment the times for reading the automatic defibrillator identifying code are preprogrammed. If, according to defibrillator data received from the presence detection device 28, it appears that an automatic defibrillator 260-i is missing or that the wrong type of automatic defibrillator 260-i is at a given location on a given mount 250-i, the central monitoring station 100 can then trigger an alarm or transmit this information to a management system.

The automatic defibrillator identifying element 266 can be of optical type, e.g. a barcode, a two-dimensional code, or even a digital tattooing type of code hidden in a piece of text on the automatic defibrillator 260 such as that known under the name Watermark, or a code associated to an image recognition algorithm. In these cases, the reading device 281 comprises an optical reading device such as a linear array of diodes, a two-dimensional optical sensor, a camera or a laser. These reading devices are equipped with image processing devices in a way known per se. In another embodiment, the automatic defibrillator identifying element 266 is of electronic type. This can, for example, be realized by an assembly of switches, a matrix of diodes, a semiconductor type of memory, etc. In these cases, the reading device 281 is of electronic type able to examine, for example, the open or closed condition of contacts, the diode matrix, or to read the semiconductor memory. This reading can be done either by using a direct electrical connection between the automatic defibrillator identifying element and the reading means, or by using a radio, inductive or capacitive connection. A battery 284 is provided for powering the presence detection device 280. In some embodiments, the battery 284 can be arranged so as to power the identifying element 266 of the automatic defibrillator 260. The presence detection device 280 according to some embodiments also comprises electronic processing means 285 comprising means of testing the power supply status of the battery 284 and arranged so as to transmit an alarm, using the radio means of the communications module 283, to the central monitoring station 100 when they detect too low a level of residual power in the battery.

In a particular embodiment, the electronic processing means 285 are arranged so as to trigger, right at the location of the automatic defibrillator mount, a visual or sound alarm to locally warn of an operational malfunction, e.g. too low a residual power level in the battery. In the first embodiment of the central monitoring station illustrated in FIG. 4, the central monitoring station 100 is realized with a single housing 110 that groups together a set of computerized means of management 101, signaling 102, control 103 and communications 104. The central monitoring station 100 also comprises a processor 105 to manage these means and memory 106 to store the data. The central monitoring station 100 is configured to detect the absence of any one of automatic defibrillator 260-1 . . . 260-n, from its operating position 250-1 . . . 250-n and to verify, according to defibrillator data received from defibrillator presence detection or identification device apparatuses 280-1 . . . 280-n, that each of the automatic defibrillators 260-1 . . . 260-n is placed at the right location in the area to be protected. The central monitoring station 100 is configured to signal the situation with regard to the location of automatic defibrillators by visual and/or audible means and to control said automatic defibrillator presence detection devices 280-1 . . . 280-n. The communications means 104 comprise a wireless interface including a device to receive and transmit radio signals, fitted with an antenna to allow the control unit to communicate with the automatic defibrillator presence detection devices 280-1 . . . 280-n by means of the wireless connections 50-1 . . . 50-n.

FIG. 5 shows the front face 112 of the housing 110 comprising indicators 113, 114A and 114B, which represent the status of the automatic defibrillators of the monitoring system, a sound emitter 115 and a display screen 116. The sound emitter 115 is of a type known, for example, in fire alarms and is designed to emit an audible alarm signal.

The display screen 116 allows the control unit to display visual messages aimed at a user of the central monitoring station and/or at a member of the maintenance team for this device. In particular, the display screen 116 is designed to display an alarm indicator.

The housing 110 can be fitted, in a way known per se, with means enabling a connection towards central monitoring and control means, via a telephone line, the Internet or other means.

The central monitoring station 100 is configured to know the identifying code of each automatic defibrillator 260-1 . . . 260-n placed on each mount 250-1 . . . 250-n according to data received from defibrillator presence detection or identification devices. By comparing the identifying code of automatic defibrillator 260-1 . . . 260-n and the identifying code of mounts 250-1 . . . 250-n held in a data table in the memory 106, the central monitoring station 100 can verify that all the mounts 250-1 . . . 250-n correctly hold the intended automatic defibrillators 260-1 . . . 260-n.

In an embodiment, the data table contains the identifying codes of all the automatic defibrillator mounts 250-1 . . . 250-n, the corresponding locations of said mounts and the type of automatic defibrillator that must be used in each location. The data table contains the automatic defibrillator identifying codes of the different automatic defibrillators, the nature of the automatic defibrillators and, where appropriate, the identifying code of the mounts on which they must be placed.

In the same way, the central monitoring station 100 can verify that automatic defibrillators of the correct type are placed at the right location.

Thus, the control unit can detect the fact that any automatic defibrillator 260-i has been removed from its mount 250-i and has not been put back. It can also check that the automatic defibrillators 260-1 . . . 260-n placed on the mounts 250-1 . . . 250-n are of the type intended at the location of the mount in question. For this, the data table contains not only an identifier of the automatic defibrillator but also its nature and/or the last maintenance inspection date.

In a second embodiment of the invention shown in FIG. 6, an automatic defibrillator identifying device 380 comprises a reading device 381 for reading the identifying code allowing an automatic defibrillator to be identified; an activation circuit 382 for activating the reading device 381, a communications module 383 comprising a wireless interface for linking the identifying device 380 to the central monitoring station 100 of the security system by means of the wireless connection 50; and a power supply battery 384 for powering the automatic defibrillator identifying device 260. The automatic defibrillator identifying device 380 also comprises a verification device 340 for detecting an operating fault of the automatic defibrillator identifying device and/or of the automatic defibrillator, and a signaling device 350 able to signal the operating fault in the automatic defibrillator identifying device and/or in the defibrillator detected by the verification device 340, at the location of the automatic defibrillator identifying device 380. In another embodiment, an alarm device can be provided in the automatic defibrillator identifying device 380 to generate an alarm signal in case of an operating fault when a test button is operated.

In the embodiment shown in FIG. 6, the verification device 340 is arranged so as to check the quality of the radio communications between the identifying device and the central monitoring station 100. To this end, at predefined times, the radio means of the communications module 330 emit an interrogation message aimed at the central monitoring station 100 and listen to a response signal coming from this central station 100.

If no response is received or in the event of poor-quality radio communications (e.g. of a phase, frequency or amplitude modulation presenting too weak a signal-to-noise ratio), a warning message is transmitted to the central monitoring station 100. In addition, a message can be emitted locally in a visual or sound form by means of the signaling device 350.

It should be noted that this visual or sound signal can have characteristics that depend on the quality of the radio connection. This can be especially useful during the positioning of automatic defibrillator mounts 260-1 . . . 260-n in the outfitting phase of buildings. For example, the installer can activate the verification means 340 of the radio connection, move about in the area where the automatic defibrillator must be placed and, by observing the sound or light signal, find the location for which the radio communication is optimum. One can, for example, provide for the repetition frequency of the sound pulses to get higher as the quality of the connection improves.

In another embodiment, it is the central monitoring station 100 that regularly emits radio interrogation messages towards the different automatic defibrillator mounts 260 and listens to the response signals emitted by the various automatic defibrillator mounts 260-1 . . . 260-n.

In this way, an absence of response or poor quality of the radio connection of one of the mounts can be signaled and transmitted to the management means.

In a particular embodiment the verification processor 340 can be configured so as to send a test signal to the central monitoring station 100 and to wait for a response signal coming from the central monitoring station 100 so as to verify the (wireless or wired) connection 50. Failure to receive a response or receiving a response signal with low intensity may indicate a faulty wireless connection.

In a particular embodiment the verification device 340 can be arranged so as to detect the working condition of the automatic defibrillator 260, for example the power supply status of the defibrillator. Thus, the verification device can be arranged so as to measure a parameter representative of the quantity of power remaining in the power source of the automatic defibrillator and the signaling means 250 can be configured to signal that the quantity of power remaining is less than a predefined quantity.

In another embodiment, the signaling means 350 can be configured so as to generate different signals depending on an operating fault of the automatic defibrillator identifying device 380. For example, the signaling means 350 may comprise a first warning indicator dedicated to communications faults with the central monitoring station and a second warning indicator dedicated to power supply faults. Thus, the first warning indicator emitting a visible signal indicates a communications fault and the second warning indicator emitting a visible signal indicates a power supply fault. In variants, a single indicator can be configured to emit different colors depending on the operating fault or to blink at different frequencies depending on the operating fault. In other variants, a sound signal can be emitted by the signaling means to warn of the operating fault. Different sounds can be emitted depending on the operating fault detected or the emission frequency of these sounds can vary depending on the operating fault or these sounds can be emitted in the form of impulses at repetition frequencies that depend on the operating fault.

In a third embodiment of the invention, shown in FIG. 7, an automatic defibrillator identifying device 480 is equipped with a detector of the presence of at least one person in its vicinity 460. The person presence detector 460 is configured to emit a command signal towards the signaling device 450 so as to only operate the signaling means 450 in the presence of at least one person in the vicinity of the automatic defibrillator identifying device 480. Such a collaboration between the presence detector 460 and the signaling means 450 makes it possible to avoid utilizing signaling means 450 in the absence of a person in its vicinity, which might consume the little power remaining in the power supply battery.

In this embodiment, in a first variant, the detector of the presence of a person 460 comprises a detector of infrared rays for detecting the infrared rays coming from an associated emitter of infrared rays. The absence of or reduction in the reception of infrared rays coming from the emitter of infrared rays would indicate the presence of one or more persons in the vicinity of the automatic defibrillator identifying device 480. In another variant, the person presence detector 460 comprises a detector of infrared rays for detecting the infrared rays coming from one or more persons in the vicinity of the automatic defibrillator identifying device. The appearance of these infrared rays would indicate the presence of one or more persons in the vicinity of the automatic defibrillator identifying device 480.

The person presence detector 460 can be incorporated in the automatic defibrillator identifying device 480 or can be a device separate from the automatic defibrillator identifying device 480 and be associated with the automatic defibrillator identifying device 480.

In the first and second embodiments of the invention, the reading device 281 constitutes means of detecting the presence of a defibrillator and also means of identifying the defibrillator. By reading the identifying code of the defibrillator, the presence of the defibrillator is detected. In other embodiments, the means of detecting the presence of a defibrillator in its mount can be realized in another way.

A defibrillator presence detection device according to a fourth embodiment is represented schematically in FIG. 8. The automatic defibrillator presence detection device 580 comprises a defibrillator presence/absence detection module 581; a communications module 583 to link the presence detection device 580 to the central monitoring station 100 of the security system by means of a connection 50; an activation circuit 582 for activating the communications device 583, a power supply battery 584 for powering the automatic defibrillator presence detection device 580.

In a particular embodiment, the defibrillator presence detection device can be equipped with a recharging device 585 for recharging the power supply source of the defibrillator. In addition, the presence detection device can be equipped with a verification device for detecting the recharge status of the power supply source of the defibrillator.

The module for detecting the presence/absence of the defibrillator 581 from its mount can be realized in any known way. This can be, for example, by using an electrical contact that is closed when the defibrillator is in its mount and open when the defibrillator is not in its mount. Of course, it is possible to have the electrical contact open when the defibrillator is in its mount and closed when not in it. This can also be by using any system utilizing a magnetic field. In that case, a magnet that creates a permanent magnetic field is fixed to the automatic defibrillator and cooperates with a flexible plate switch (reed switch) or a Hall effect circuit fixed on the mount. Or again, this can be a system wherein electrodes fixed respectively on the automatic defibrillator and on the mount cooperate to form a capacitor.

When the presence/absence detection module 581 detects that the defibrillator is no longer present in its operating position, a defibrillator absence signal is sent to the central monitoring station 100 of the security system by the connection 50.

The activation circuit 582 can be configured so as to activate the communications module 583 when the module for detecting the presence of an automatic defibrillator 581 detects the absence of the defibrillator from its operating position.

In another embodiment, a presence detection device can be equipped with separate defibrillator presence detection means and defibrillator identifying means.

In a particular embodiment, the presence detection device can comprise a defibrillator presence detection module as described above for the fourth embodiment and a reading device as described previously for the third embodiment for reading an identifying code of the automatic defibrillator allowing an automatic defibrillator to be identified.

The activation means can be able to activate the identifying means when the means of detecting the presence of an automatic defibrillator detect the absence of the automatic defibrillator from its operating position.

In a particular embodiment, the times for reading the automatic defibrillator identifying code by the reading device are preprogrammed and triggered in response to the detection by the defibrillator presence/absence detection means of the removal of an automatic defibrillator from its mount and to an automatic defibrillator being put back in place. Thus, the activation means are able to activate the identifying means at predefined times after the means of detecting the presence of an automatic defibrillator have detected the removal of an automatic defibrillator from its mount and said means of detecting the presence of an automatic defibrillator have detected an automatic defibrillator being placed back on its mount. In this way, after the defibrillator has been put back, the reading device can read the identifying code of the defibrillator in order to transmit it to the central monitoring station. If it appears that an automatic defibrillator 260-i has not been put back in the intended location or that the wrong type of automatic defibrillator 260-i is at a given location on a given mount 250-i, the central monitoring station 100 can then trigger an alarm or transmit this information to a management system. A defibrillator presence detection device according to a fifth embodiment of the invention is represented schematically in FIG. 9. The automatic defibrillator presence detection device 680 comprises a defibrillator presence/absence detection module 681; a communications module 683 to link the presence detection device 680 to the central monitoring station 100 of the security system by means of a connection 50; and a power supply battery 684 for powering the automatic defibrillator presence detection device 680.

In this embodiment the defibrillator presence detection module is configured so as to activate the communications module 683 when a defibrillator is removed from its mount. To do this, the defibrillator presence/absence detection module comprises an electrical contact, which is in an open position when the defibrillator is in its mount and closed when not in it.

In this way, when the defibrillator is no longer present in its operating position the communications module 683 is activated to automatically send a defibrillator absence signal to the central monitoring station 100 of the security system by the connection 50. Since the communications device is only activated when the defibrillator is absent, economies in the power supply of the defibrillator presence detection device 680 are realized. It goes without saying, and is demonstrated moreover in the preceding description, that the invention is in no way restricted to those modes of application and embodiments that have been more particularly envisaged; on the contrary, it encompasses all the variants without in any way departing from the scope of the invention, such as it is defined by the claims.

When several defibrillators are placed in a building, a system architecture such as that described for the defibrillators can be used. On the other hand, when the defibrillators are placed relatively far apart from each other, the radio connection may be made to a Wi-Fi-type base located in the vicinity, or by using a GSM, DCS 1800, CDMA, LTE, etc. type of cellular telephone network.

In this case, one can also provide a monitoring service for defibrillators with applications for Smartphone-tablet-, I-Phone-, Android-type mobile terminals. This can allow witnesses of a cardiorespiratory accident to very quickly know the location of the closest defibrillator stations and to verify that these stations' portable defibrillators are on their mount.

1-42. (canceled)

43. A presence detection device for detecting a presence of an automatic defibrillator, comprising:
a detector to detect the presence of the automatic defibrillator in its operating position and to obtain defibrillator data relating to the automatic defibrillator, the detector comprising an automatic defibrillator identifier configured to obtain identifying data of the automatic defibrillator;
a communication device configured to transmit the defibrillator data to a management device; and
an activation device to activate at least one of the communication device and a detector in response to a predefined event;
wherein the activation device activates the automatic defibrillator identifier at a predefined time after the detector has detected an absence of the automatic defibrillator from its operating position and then detected the presence of the automatic defibrillator back in its operating position.

44. The device according to claim 43, wherein the activation device is configured to activate the communication device when the detector has detected that the automatic defibrillator is not in its operating position.

45. The deice according to claim 43, wherein the automatic defibrillator identifier is configured to read an identifying element on the automatic defibrillator to obtain the identifying data of the automatic defibrillator.

46. The device according to claim 45, wherein the automatic defibrillator identifier is configured to communicate with the identifying element of the automatic defibrillator via a wireless connection to verify an identifying code for the automatic defibrillator.

47. The device according to claim 43, wherein the activation device is configured to activate the automatic defibrillator identifier in response to an interrogation signal from the management device.

48. The device according to claim 43, wherein the activation device is configured to activate the automatic defibrillator identifier at predefined times.

49. The device according to claim 43, further comprising a mount to support an automatic defibrillator, the mount comprising an identifying element for the mount to supply the management device with identifying data of the mount, thereby permitting the mount to be identified.

50. The device according to claim 43, further comprising a signaling device to signal an absence of the automatic defibrillator at the location of the detector.

51. The device according to claim 50, wherein the signaling device is configured to signal a device operating fault.

52. The device according to claim 43, further comprising a second detector to detect a presence of at least one person in a vicinity of the presence detection device and a signaling device configured to signal a visible or audible alarm when an absence of the automatic defibrillator in its operating position is detected by the detector and when the presence of a person is detected in the vicinity of the detector by the second detector.

53. The device according to claim 43, further comprising a verifier to check a working condition of the presence detection device to supply information representative of the working condition of the presence detection device to the management device.

54. The device according to claim 53, wherein the verifier is configured to verify a power source status of the presence detection device.

55. The device according to claim 53, wherein the verifier is configured to verify a condition of a connection between the presence detection device and the management device.

56. A management device for a security system, comprising:
a second communication device configured to be linked via a connection to at least one presence detection device according to claim 43 to receive the defibrillator data; and
a data processor to obtain information about the automatic defibrillator as a function of the defibrillator data received.

57. The device according to claim 56, wherein the data processor obtains information about at least one of the following: a status of the automatic defibrillator and a location of the automatic defibrillator.

58. The device according to claim 56, wherein the data processor obtains data identifying an automatic defibrillator's mount and determines whether the data identifying the automatic defibrillator's mount corresponds to the identifying data of the automatic defibrillator.

59. An automatic defibrillator system, comprising:
a presence detection device according to claim 43;
an automatic defibrillator device comprising electrodes to be placed on the victim's chest, the automatic defibrillator device configured to analyze a heart rate and to deliver an electric shock to the victim;
a power supply source;
a defibrillator housing to receive the power supply source and to which the electrodes are connected;
a memory for recording heart function parameters; and
an identifying element, which can be read by the automatic defibrillator identifier, to identify the automatic defibrillator.

60. The device according to claim 59, wherein the identifying element is configured to communicate with the automatic defibrillator identifier via a wireless connection to supply an identifying code associated with the automatic defibrillator.

61. A monitoring method for a security system comprising a management device and at least an automatic defibrillator presence detection device configured to communicate with the management device; the method comprising the steps of:
activating the defibrillator presence detection device;
detecting a presence of an automatic defibrillator by the defibrillator presence detection device;
transmitting defibrillator data to the management device;
verifying the defibrillator data;
activating an identifier of an automatic defibrillator at predefined times after the defibrillator presence detection device has detected an absence of the automatic defibrillator from its operating position and the defibrillator presence detection device has detected a presence of the automatic defibrillator back in its operating position;
identifying the automatic defibrillator by the identifier; and
verifying identifying data of the automatic defibrillator.

62. The method according to claim 61, further comprising the steps of obtaining data identifying a mount of the automatic defibrillator; and verifying that the identifying data of the automatic defibrillator correspond to the identifying data of the mount.
